(19) United States
(12) Patent Application Publication
(10) Pub. No.: US 2009/0167929 A1
(43) Pub. Date: Jul. 2, 2009

(54) Imaging apparatus

(76) Inventor: Toshiyuki Nagaoka, Tokyo-to (JP)

Correspondence Address: KENYON & KENYON LLP, ONE BROADWAY, NEW YORK, NY, 10004, US

(21) Appl. No.: 12/380,421

(22) Filed: Feb. 26, 2009

Related U.S. Application Data
(62) Division of application No. 10/798,483, filed on Mar. 12, 2004.

(30) Foreign Application Priority Data
Mar. 13, 2003 (JP) 2003-068276

(51) Int. Cl. H04N 5/232

(52) U.S. Cl. 348/345; 348/E05.024

(57) ABSTRACT

The imaging apparatus comprises plural optical systems having different focal length from that of an imaging element, a transmittance variable element and a reflective optical element, It is constituted so that the focal length is changed by controlling transmittance of the transmittance variable element. Thus, a compact structured and small sized multi-focus imaging apparatus can be provided.

### BACKGROUND OF THE INVENTION

1. Field of the Invention

The present invention relates to the imaging apparatus having different focal lengths.

2. Description of Related Art

The needs of carrying an optical system in mobile apparatus including a cellular phone have become strong in recent years. The optical system used for these mobile apparatus and others is a single focal optical system under the present circumstance. Therefore, there are many apparatus using the electric enlarging function. However, in an electric enlarging, since at the time of enlarging degradation of image quality cannot be avoided, the imaging system which can change a focal length optically is demanded. As such an optical system, there are optical systems, such as a digital still camera, a video camera and a silver-salt camera. In such optical systems, in order to realize a different focal length, zoom optical system having movable lens group in the optical system has been used.

However, especially in the mobile apparatus, durability against a shock in possible fall to the ground at the time of handling is severely demanded, unlikely in the digital camera or the video camera and others. Therefore, it is very difficult to establish a mechanical movable mechanism. Moreover, the mechanical durability against the shock or vibration is required also in the imaging apparatus equipped on moving vehicles such as a car, a train, and others as well as on a security use. Therefore, the imaging apparatus which has an optical system with movable mechanism is not desirable.

Then, an imaging apparatus which enables to change the specification of an optical system at low cost, without having a mechanical movable part in various fields including the said industrial fields is strongly demanded in recent years. There is a multi-focal camera shown in the patent literature 1 (Japan Unexamined Patent Application Publication No. Toku Kai Hei 11-311832) to meet such a demand. The multi-focal camera shown in the patent literature 1 enables it to choose the optical system of different focal lengths by changing optical path using light control elements such as a liquid crystal element.

### SUMMARY OF THE INVENTION

The imaging apparatus according to the present invention comprises an imaging element, plural optical systems having different focal length from that of the imaging element, a transmittance variable element, and a reflective optical element wherein the focal length is changed by controlling transmittance of the transmittance variable element.

In order to realize an imaging apparatus having variable focal length without having a mechanical movable part, it is desirable to use plural optical systems of which specification such as a focal length differs. In that case, it is desirable that any of plural optical systems is arranged so that it may form an image on the same imaging element. Furthermore, if the optical element of which transmittance is variable in an optical path is used, the optical path can be changed by controlling this. Consequently, it becomes possible to choose a desired optical specification. Furthermore, in order to achieve a compact constitution in case that plural optical systems are used, it is desirable to use a reflective optical element.

By arranging the reflective optical element in the optical path and by bending the optical path, it becomes possible to realize a compact imaging apparatus, in spite of having plural optical systems.

According to the present invention, an imaging apparatus comprises an imaging element, plural optical systems having different focal length from that of the imaging element, a transmittance variable element, and a reflective optical element. And it is characterized in that the focal length is changed by controlling transmittance of the transmittance variable element arranged at the object side rather than the said plurality of optical system.

In order to realize a focal length variable imaging apparatus without having a mechanical movable part, it is desirable to use optical systems and a transmittance variable element of which specifications such as a focal length etc. are different. Furthermore, in order to get a cheap constitution it is desirable that the transmittance variable element is arranged at the object side rather than the said plurality of optical system. As apparatus suitable for the imaging apparatus of the present invention, there are mobile apparatus such as a cellular phone, cameras used for vehicles, and others. These apparatus are used in many cases in the environment where possibility of fall to the ground and a big shock by vibration and others are supposed. Accordingly, possible breakage and functional degradation of the transmittance variable element is a matter of concern. It is desirable to arrange the transmittance variable element utmost object side. By such arrangement, replacement of the transmittance variable element can be carried out easily. If a transmittance variable element is arranged in an optical system, cost will be high since the replacement is not easy.

Furthermore, according to the present invention, an imaging apparatus comprises an imaging element, a lens having partially different focal length and a transmittance variable element. And it is characterized in that the focal length is changed by changing partially the transmittance of the transmittance variable element.

As described above, it is also possible to change a focal length by using the lens in which a focal length differs partially and the transmittance variable element without having a movable part. For example, in one optical system, the radius of curvature near the optical axis of a lens and the radius of curvature of the circumference of the lens with respect to the optical axis shall be different. By such way, an optical system with different focal lengths is available. By such way that a transmittance variable element is used for this optical system, and transmittance is locally changed, the penetration domain of luminous flux which penetrates a lens can be controlled and a desired focal length can be chosen.

Moreover, when using plural optical systems in the imaging apparatus according to the present invention, it is desirable that plural optical systems correspond to one imaging element. In this case it is desirable that the center of the imaging area of the imaging element is developed along the optical axis of the plural optical systems.

It is desirable that the imaging apparatus of the present invention has at least one optical system equipped with the reflective function and the transmittance variable function.

It is desirable that the imaging apparatus of the present invention has at least one optical element with reflective function, and the amount of the light penetrated in the optical element and the amount of the light reflected is substantially equal.

It is desirable that the imaging apparatus of the present invention has plural imaging elements and constitutes an imaging unit forming one pair with the plural optical systems having different focal length.

It is desirable that the imaging apparatus of the present invention, the lens and the transmittance variable elements are arranged in adjacent position each other.

It is desirable that the imaging apparatus of the present invention, plural transmittance variable elements are arranged in one optical system.

It is desirable that the imaging apparatus of the present invention, the transmittance variable element is arranged in adjacent position of the aperture stop of the optical system.

It is desirable that the imaging apparatus of the present invention, the transmittance variable element has a transmittance distribution.

It is desirable that the imaging apparatus of the present invention, the transmittance variable element does not have a portion which is mechanically movable when a photographing is carried out.

It is desirable that the imaging apparatus of the present invention, a body frame holding the optical system and a body frame holding the transmittance variable element are individually constituted respectively.

It is desirable that the imaging apparatus of the present invention, at least plural optical systems out of the optical systems are arranged in adjacent position each other, and a shading member is disposed between two optical systems.

It is desirable that the imaging apparatus of the present invention, an electrochromic material is used as the transmittance variable element.

It is desirable that the imaging apparatus of the present invention is equipped with a display part which checks a photographing state, an operation part for choosing a desired focal length, a transmittance control device which drives the transmittance variable element, a power supply part for operating the transmittance control device, and a control part which controls the transmittance of the transmittance variable element by the signal generated from the operation part.

It is desirable that the imaging apparatus of the present invention is equipped with a sensor part for checking a state of a photographing object, an operation processing part in order to recognize a photographing object with the signal from the sensor part, a control part which drives the transmittance variable element, a power supply part for operating this transmittance control device, and a control part which controls the transmittance of the transmittance variable element according to the photographing object recognized.

In this apparatus, processing for resetting a transmittance control of the transmittance variable element for imaging to an initial state is carried out, after an imaging operation is completed.

It is desirable that in the imaging apparatus of the present invention, at least one of the optical system has a constitution in that a first lens group with negative refractive power and a second lens group with positive refractive power are arranged in order from an object side.

It is desirable that in the imaging apparatus of the present invention, at least one of the optical system has a constitution in that at least one negative lens and at least one positive lens wherein the negative lens is arranged utmost to an object side.

It is desirable that the imaging apparatus of the present invention satisfies the following condition:

1.9<fT/fW

where fT is a focal length of a telephoto lens, and fw is a focal length of a wide angle lens.

It is desirable that the cellular phone of the present invention is equipped with the imaging apparatus of the present invention.

Furthermore, it is desirable that the moving object of the present invention is equipped with the imaging apparatus of the present invention.

These and other features and advantages of the present invention will become apparent from the following detailed description of the preferred embodiments when taken in conjunction with the accompanying drawings.

### BRIEF DESCRIPTION OF THE DRAWINGS

FIG. 1 is a sectional view showing an optical arrangement, developed along the optical axis about the first embodiment of the imaging apparatus according to the present invention.

FIG. 2 is a sectional view showing an optical arrangement, developed along the optical axis about the second embodiment of the imaging apparatus according to the present invention.

FIG. 3 is a sectional view showing an optical arrangement, developed along the optical axis about the third embodiment of the imaging apparatus according to the present invention.

FIG. 4 is a sectional view showing an optical arrangement, developed along the optical axis about the fourth embodiment of the imaging apparatus according to the present invention.

FIG. 5 is a sectional view showing an optical arrangement, developed along the optical axis about the fifth embodiment of the imaging apparatus according to the present invention.

FIGS. 6A and 6B are sectional views showing optical arrangements, developed along the optical axis about the sixth embodiment of the imaging apparatus according to the present invention, which are drawings for explanation showing respectively states where the transmittance of the transmittance variable element is partially changed.

FIGS. 7A and 7B are sectional views showing optical arrangements, developed along the optical axis about the seventh embodiment of the imaging apparatus according to the present invention, which are drawings for explanation showing respectively states where the transmittance of the transmittance variable element is partially changed.

FIGS. 8A and 8B are sectional views showing respectively optical arrangements, developed along the optical axis about the eighth embodiment of the imaging apparatus according to the present invention,

FIG. 9 is a sectional view showing an optical arrangement, developed along the optical axis about the ninth embodiment of the imaging apparatus according to the present invention.

FIG. 10 is a diagram showing outlined constitution of the tenth embodiment of the imaging apparatus according to the present invention.

FIG. 11 is a diagram showing outlined constitution of the eleventh embodiment of the imaging apparatus according to the present invention.

FIGS. 12A and 12B are a front view and a rear view showing outlined constitution of the twelfth embodiment of the imaging apparatus according to the present invention.

### DETAILED DESCRIPTION OF PREFERRED EMBODIMENTS

### First Embodiment

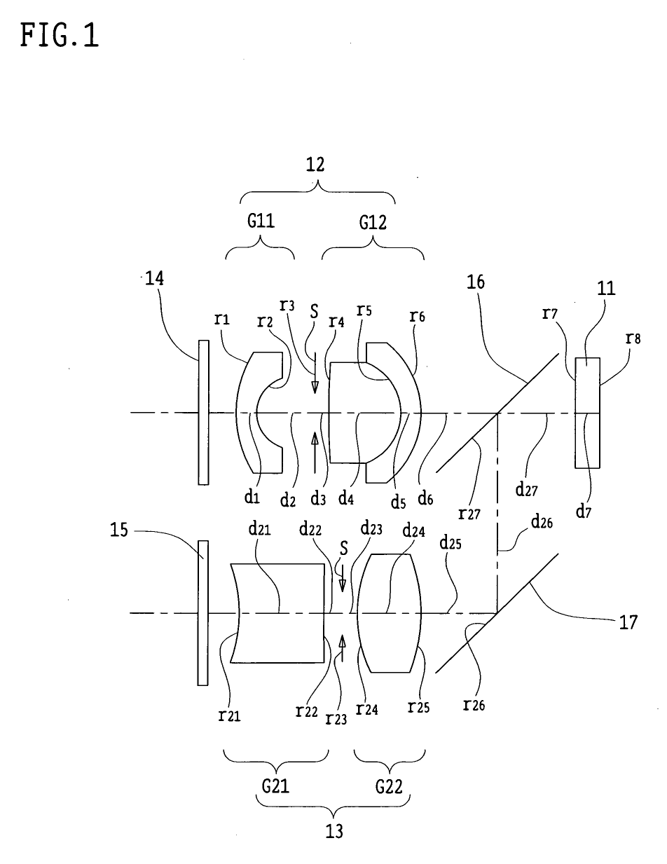

FIG. 1 is a sectional view along the optical axis showing an optical constitution of the first embodiment according to the present invention.

In this figure, reference numeral 11 is an imaging element, such as CCD and CMOS, and reference numerals 12 and 13 express optical systems of different specifications respectively. Reference numeral 14 is a transmittance variable element corresponding to the optical system 12, and 15 is a transmittance variable elements corresponding to the optical system 13. Reference numeral 16 is an imaging apparatus having so-called half mirror which has a reflective function as well as a penetration function, and 17 is an imaging apparatus having a mirror which has only a reflective function.

In this embodiment, a transmittance variable element uses electrochromic element (ECD: Electrochromic Device) which has coloring function and decoloring function in reversible way by supplying voltage, and it is also possible to use a liquid crystal element (LCD).

Optical systems 12 and 13 are optical systems which have different focal lengths respectively. The optical system 12 has a function as a wide angle lens, and the optical system 13 has the function as a telephoto lens. The optical system 12 and the optical system 13 are arranged in parallel. And the imaging element 11 is arranged on the optical axis of the optical system 12. In such constitution, by using the reflective optical element in this embodiment, any luminous flux which penetrated either of the optical systems can be led to the imaging element 11. That is, luminous flux which penetrated the optical system 12 penetrates a half mirror 16 and is led to the imaging element 1. Meanwhile, luminous flux which penetrated the optical system 13 is reflected by the mirror 17 and is led to the imaging element 11 by the half mirror 16.

The imaging apparatus according to the present invention, as mentioned above, is constituted that plural optical systems are corresponded to one imaging element. And the center of an imaging area of the imaging element and the optical axis of plural optical systems approximately coincide. Therefore, although the number of imaging elements is one, a compact and cheap constitution can be realized.

In case of photographing a wide angle picture by the imaging apparatus according to this embodiment, control is carried out so that a desired transparent state of the transmittance variable element 14 is obtained and meanwhile the transmittance variable element 15 is in a shading state. In case of photographing a telephoto picture, control is done so that a desired transparent state of the transmittance variable element 15 is obtained and meanwhile the transmittance variable element 14 is controlled to be in a shading state.

The optical system 12 in the first embodiment comprises two groups of lens where in order from the object side, a negative first lens group G11 and a positive second lens group G12. An aperture stop S is disposed between the first lens group G11 and the second lens group G12. Since the optical system 12 is an optical system with wide angle and it is required that a reflective optical element is arranged between the second lens group G12 and the imaging element, constitution having long back focus is needed. Therefore, the first lens group G11 having negative power which is arranged at preceded position is a retrospective focus type. Moreover, the first lens group G11 has one negative lens and the second lens group G12 has one positive lens and one negative lens. Thus, by adopting a symmetrical power arrangement in order of negative-positive-negative power, especially, in spite of a wide angle lens system, aberration of decentering can be suitably compensated. Particularly, in order to compensate suitably chromatic aberration of magnification, the second lens group G12 is formed as a junction lens.

The optical system 13 is constituted that in order from the object side the negative first lens group G21 with negative power and the second lens group G22 with positive power are arranged. An aperture stop S is disposed between the first lens group G21 and the second lens group G22. Since a reflective optical element is used between the second lens group G22 and the imaging elements, a constitution having a long back focus is needed. Therefore, irrespective of a telephoto lens, a retrospective focus type which the first lens group with negative refracting power precedes is adopted. Moreover, the first lens group G21 consists of one lens with negative power, and the second lens group G22 has one lens with positive power.

Although an example in which a wide angle lens (the optical system 12) and a telephoto lens (the optical system 13) are combined is shown in this embodiment, it is not restricted to this example. In the imaging apparatus according to the present invention, it is also possible to be constituted by combining two or more optical systems which can take photograph of a long distant object as well as a short-distance object, and by plural optical systems with different F value (F-number). Moreover, although the transmittance and reflective ratio of a half mirror 17 are almost equal, a desired ratio of them can be chosen.

Lens data of optical members constituting the optical system of the first embodiment are listed below.

In the numerical data, r₁, r₂, - - - denote radii of curvature of individual lens surfaces; d₁, d₂, - - - denote thickness of individual lenses or air space between them; n_{d1}, n_{d2}, - - - denote refractive indices of individual lenses at the d line; ν_{d1}, ν_{d2}, - - - denotes Abbe's numbers of individual lenses; Fno. denotes an F number; f denotes a total focal length, and D0 denotes distance from an object to the first surface of a lens element.

Also, when z is taken as the coordinate in the direction of the optical axis, y is taken as the coordinate normal to the optical axis, K represents a conic constant, and A₄, A₆, A₈ and A₁₀ represent aspherical coefficients, the configuration of each of the aspherical surface is expressed by the following equation:

$$z = ( {y}^{2} / r ) / [ 1 + {\{ 1 - ( 1 + K ) {( y / r )}^{2} \}}^{1 / 2} ] + {A}_{4} {y}^{4} + {A}_{6} {y}^{6} + {A}_{8} {y}^{8} + {A}_{10} {y}^{10}$$

These symbols hold for the numerical data of the embodiments to be described later.

In the imaging apparatus according to the present invention, it is desirable that the following condition is satisfied in order to obtain a variable focussing effect.

1.9<fT/fw

where ft represents a focal length of a telephoto lens, and

fw is a focal length of a wide angle lens.

### Numerical Data 1

(optical system 12; wide angle system)
focal length f = 1.71 mm, Fno. = 2.6,
field angle 2ω = 63.0°,
object distance = ∞

| | | |
|---|---|---|
| r₁ = 2.7421 (aspherical) | | |
| d₁ = 0.3992 | n_{d1} = 1.48749 | ν_{d1} = 70.23 |
| r₂ = 0.7366 | | |
| d₂ = 1.2033 | | |
| r₃ = ∞ (aperture stop) | | |
| d₃ = 0.2000 | | |
| r₄ = 15.9081 | | |
| d₄ = 1.3950 | n_{d4} = 1.77250 | ν_{d4} = 49.06 |
| r₅ = −1.0814 | | |
| d₅ = 0.3894 | n_{d5} = 1.84666 | ν_{d5} = 23.78 |
| r₆ = −1.5448 (aspherical) | | |
| d₆ = 2.9953 | | |
| r₇ = ∞ | | |
| d₆ = 2.9953 | | |
| r₈ = ∞ (image plane) | | |

Aspherical coefficient
First surface

| | | |
|---|---|---|
| K = 0 | | |
| A₂ = 0 | A₄ = 8.3007 × 10⁻² | A₆ = −1.3676 × 10⁻¹ |
| A₈ = 1.7947 × 10⁻¹ | A₁₀ = −7.7885 × 10⁻² | |

The six surface

| | | |
|---|---|---|
| K = 0 | | |
| A₂ = 0 | A₄ = 3.3047 × 10⁻² | A₆ = 1.3745 × 10⁻³ |
| A₈ = −2.9037 × 10⁻⁴ | A₁₀ = 3.3712 × 10⁻³ | |

(optical system 13; telephoto system)
focal length f = 4.87 mm, Fno. = 4.9, field angle 2ω = 23.8°,
object distance = ∞

| | | |
|---|---|---|
| r₂₁ = −3.0610 | | |
| d₂₁ = 1.6489 | n_{d21} = 1.88300 | ν_{d21} = 40.76 |
| r₂₂ = 22.2734 | | |
| d₂₂ = 0.444 | n_{d22} = 1. | ν_{d22} = 53.21 |
| r₂₃ = ∞ (aperture stop) | | |
| d₂₃ = 0.1500 | n_{d23} = 1. | |
| r₂₄ = 2.7687 | | |
| d₂₄ = 1.2359 | n_{d24} = 1.52540 | ν_{d24} = 56.25 |
| r₂₅ = −3.0150 (aspherical) | | |
| d₂₅ = 1.5000 | | |
| r₂₆ = ∞ | | |
| d₂₆ = −4.000 | | |
| r₂₇ = ∞ | | |
| d₂₇ = 1.5000 | | |
| r₇ = ∞ | | |
| d₇ = 0.5000 | n_{d17} = 1.51633 | ν_{d17} = 64.15 |
| r₈ = ∞ (image plane) | | |

Aspherical coefficient
Twenty fifth surface

| | | |
|---|---|---|
| K = 0 | | |
| A₂ = 0 | A₄ = 2.1804 × 10⁻² | A₆ = 4.8883 × 10⁻⁴ |
| A₈ = −2.7903 × 10⁻³ | A₁₀ = 3.9161 × 10⁻³ | |

### Second Embodiment

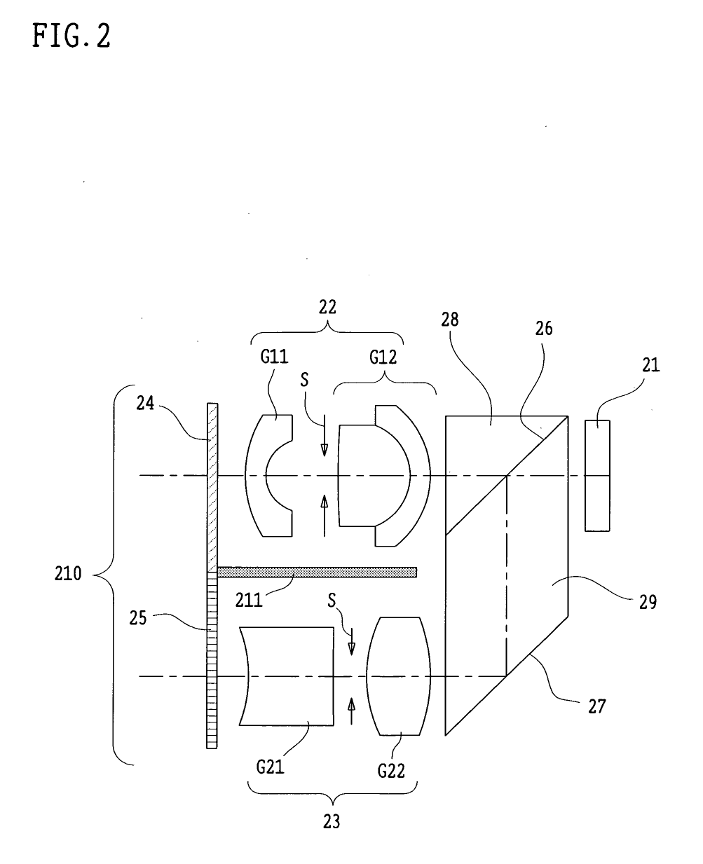

FIG. 2 is a sectional view showing an optical arrangement developed along the optical axis about the second embodiment of the imaging apparatus according to the present invention.

Although the embodiment 2 is the almost same constitution as the embodiment 1, but, in the embodiment 1 a prism optical system is used for a reflective optical element. In FIG. 2, reference numeral 21 is an imaging element, such as CCD and CMOS, and others. Reference numerals 22 and 23 are optical systems equivalent to the optical systems 12 and 13 of the embodiment 1. 210 is a transmittance variable element and 24 is a transmittance variable domain corresponding to the optical system 2, and 25 is a transmittance variable area corresponding to the optical system 3. 211 is a shading member arranged between the optical systems 22 and 23 which has the function for preventing a flare and a ghost. 28 and 29 are prisms, and 26 is a half mirror surface which has a reflective function as well as a penetration function, and 27 is a mirror surface which has a reflective function.

A luminous flux which penetrated the optical system 22 penetrates the prism 28, the prism 29, the half mirror surface 26 of the boundary of both prisms, and is led to the imaging element 21. Moreover, A luminous flux which penetrated the optical system 23 is reflected by the mirror of the prism 7, and is led to the imaging element 21 by the half mirror surface 26.

It is also possible to constitute with the prism 27 only, without using the prism 28. However, it is not desirable because the luminous flux which penetrates the optical system 22 may cause decentering due to the wedge effect by the prism 27. The prism 28 has the effect which corrects the decentering. The half mirror surface 26 can be arranged on any side of the prism 27 or the prism 28.

In this embodiment, the imaging apparatus which is excellent at assembling and enables to simplify position adjustment and a lens holder mechanism can be attained by using a prism as a reflective optical element. Moreover, since control of a transmittance variable area is carried out by a penetration light control of two optical systems it has advantageous constitution in cost.

Moreover, the shading member 211 in this embodiment can be served concurrently by a lens holder of the optical system.

### Third Embodiment

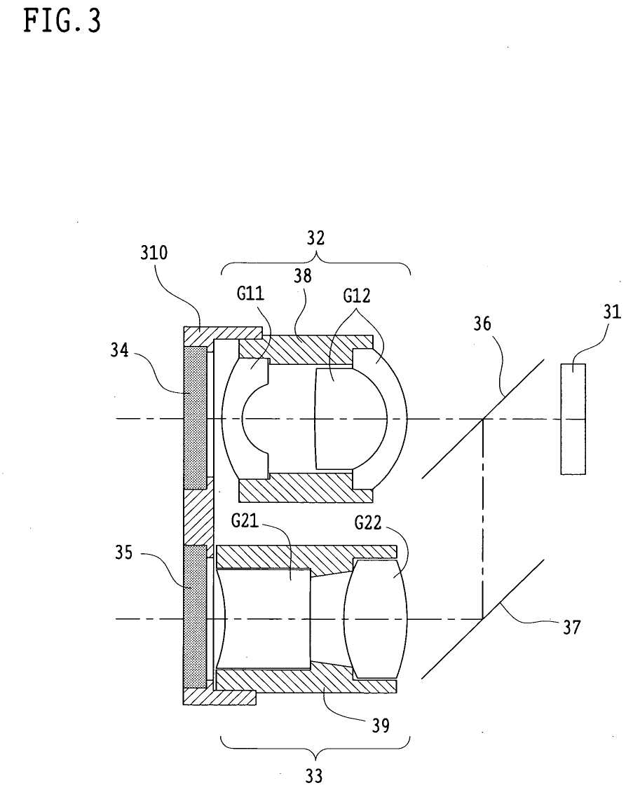

FIG. 3 is a sectional view showing an optical arrangement developed along the optical axis about the third embodiment of the imaging apparatus according to the present invention.

The third embodiment is an example taking into consideration of assembling efficiency also. In FIG. 3, reference numeral 31 is an imaging elements, such as CCD, CMOS and others. Reference numerals 32 and 33 are optical systems having different focal lengths, and for such systems the optical system equivalent to the optical systems 12 and 13 in the first embodiment can be used. The transmittance variable element 34 is corresponding to the optical system 32 and the transmittance variable elements 35 is corresponding to the optical system 33. Reference numerals 36 and 37 are optical elements which have a reflective function, and 36 is a half mirror which has a reflective function as well as a penetration function, and 37 is a mirror which has a reflective function. Moreover, 38 is a lens holder for holding the optical system 32, 39 is a lens holder holding the optical system 3, and 310 is a lens holder for holding the transmittance variable element.

There is a possibility that a transmittance variable element may be degraded in response to speed, penetration and shading performance by repeated use. Therefore, when it is used for the imaging apparatus of the present invention, it is desirable that a transmittance variable element can be easily changed. Then, as shown in this embodiment, the lens holder 310 holding a transmittance variable element is constituted separately from a lens holder for holding the optical system. By such constitution, it becomes possible to exchange a transmittance variable element easily. Moreover, in order to exchange easily a transmittance variable element, it is desirable that a transmittance variable element is arranged to an object side rather than an optical system.

### Fourth Embodiment

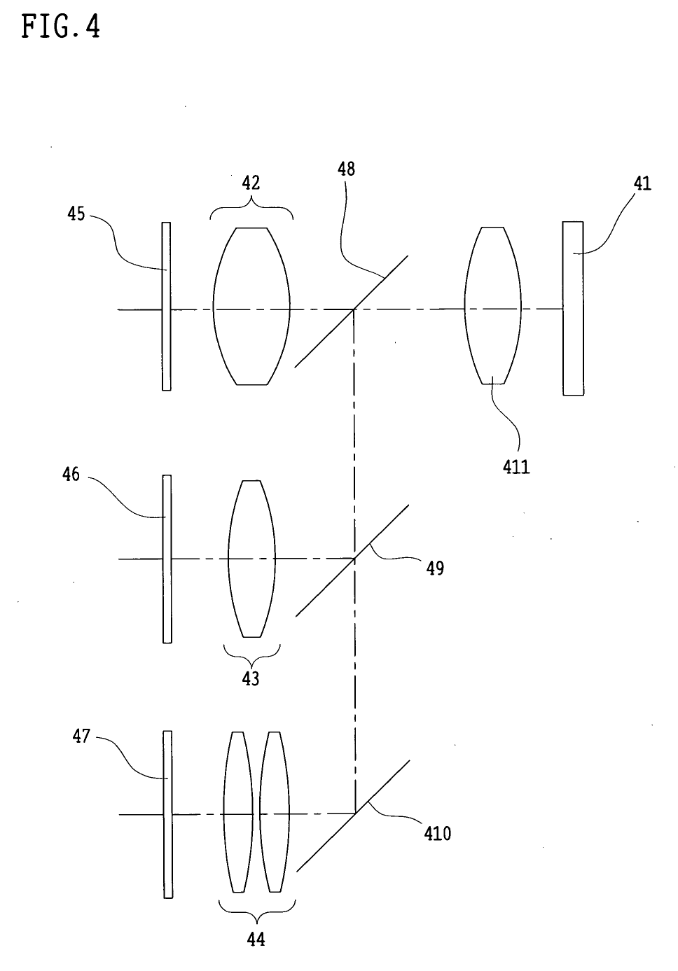

FIG. 4 is a sectional view showing an optical arrangement, developed along the optical axis about the fourth embodiment of the imaging apparatus according to the present invention.

The fourth embodiment is an example of imaging apparatus using three or more optical systems unlike the embodiments mentioned above. In FIG. 4, reference numeral 41 is an imaging element, such as CCD, CMOS and others. Reference numerals 42, 43, and 44 are optical systems having different focal lengths, and it is shown that these share a part 411 of the optical systems. Reference numeral 45 is a transmittance variable element corresponding to the optical system 42, 46 is a transmittance variable element corresponding to the optical system 3, and 47 are the transmittance variable elements corresponding to the optical system 44. Reference numerals 48, 49 and 410 are optical elements which have a reflective function, and 48 and 49 are half mirrors which have a reflective function and a penetration function, and 410 is a mirror which have a reflective function.

According to the imaging apparatus of the present invention it is possible to realize a switching apparatus which can switch plural focal lengths by using plural optical systems. Moreover, in the imaging apparatus of the present invention, it becomes possible to share a part of optical systems by plural optical systems. Therefore, a compact and cheap constitution can be realized.

### Fifth Embodiment

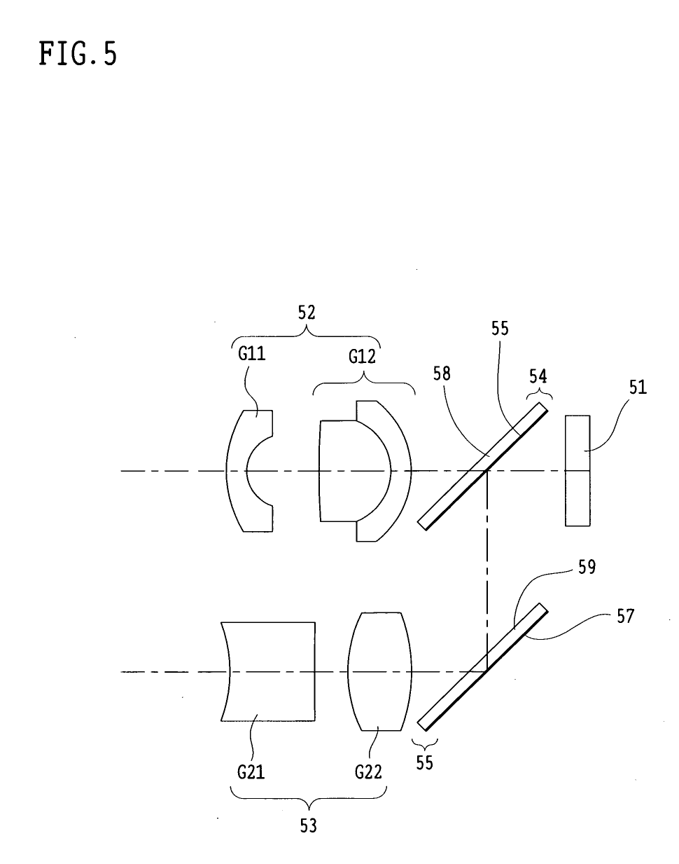

FIG. 5 is a sectional view showing an optical arrangement, developed along the optical axis about the fifth embodiment of the imaging apparatus according to the present invention.

The fifth embodiment is an example in which a reflective optical element has a transmittance variable function. In FIG. 5, reference numeral 51 is an imaging element, such as CCD and CMOS and others. Moreover, reference numerals 52 and 53 are optical systems for which an optical system equivalent to the optical systems 12 and 13 of the first embodiment can be used. Reference numerals 54 and 55 are the optical elements having a reflective function and a transmittance variable function also. Reference numeral 56 is a half mirror surface which has a reflective function as well as a penetration function, 57 is a mirror surface which has a reflective function, and 58 and 59 are optical elements with a transmittance variable function. In this embodiment, a compact and cheap imaging apparatus can be realized by giving a transmittance variable function to a reflective optical element.

In case that a photograph is taken by using the optical system 52 of the imaging apparatus of this embodiment, a control is carried out so that a transparent state of the transmittance variable element 58 reaches at a desired transmittance and the transmittance variable element 59 becomes in shading state.

On the other hand, in case that a photograph is taken by using the optical system 53 of the imaging apparatus of this embodiment, a control is carried out so that a transparent state of the transmittance variable element 59 reaches at a desired transmittance and the transmittance variable element 58 becomes in shading state.

In some case, it is difficult to set a transmittance of a transmittance variable element to zero completely at the time of shading. Then, in the imaging apparatus of the present invention, it is desirable to use plural transmittance variable elements in one optical system when it is desired that a transmittance at shading is small. For example, in addition to the constitution in the fifth embodiment, by arranging a transmittance variable element to an object side rather than two optical systems 52 and 53 as shown in the first embodiment, it is possible to raise a shading performance much more.

Moreover, in the imaging apparatus of the present invention, it is also possible to establish a threshold value in order to cut electrically the light which has a penetrating power beyond shading ability.

### Sixth Embodiment

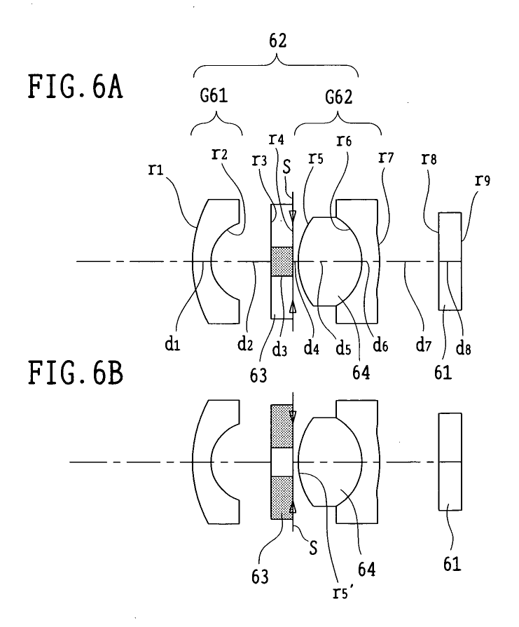

FIG. 6 is sectional views showing optical arrangements developed along the optical axis about the sixth embodiment of the imaging apparatus according to the present invention.

In FIG. 6A, reference numeral 61 is an imaging element such as CCD, CMOS and others. Reference numeral 62 is an optical system and 63 is a transmittance variable element. 64 is a multi-focal lens in which a shape of surface of an object side is formed to have partially different radius of curvature. FIG. 6B is an explanatory diagram in which a transmittance of a transmittance variable element is partially changed to FIG. 6A.

FIG. 6A shows a circular shaped shading state where a center portion of the optical axis of the transmittance variable element 63 is shaded by a circular shape and a ring-shaped transmitting state of it. On the other hand, FIG. 6B shows a shading state where a circumferential portion of the transmittance variable element 63 is shaded and a transmitting state in a center portion of the optical axis.

The optical system 62 of the sixth embodiment comprises a lens group G61 with negative power and a lens group G62 with positive power which are arranged in order from an object side, whereby a relatively wide angle lens system is realized. The negative lens group G61 consists of one negative lens and the positive lens group G62 consists of one positive lens and one negative lens. Especially the positive lens group G62 is formed as junction lens for compensation of chromatic aberration in magnification. The transmittance variable element 63 is disposed between the negative lens group G61 and the positive lens group G62. An aperture stop S for brightness control is arranged between the negative lens group G61 and the positive lens group G62.

In addition, in order to make variable uniformly and more efficiently an amount of penetrating light at the circumferential portion as well as at the near portion of the optical axis, it is desirable that the positions of a transmittance variable element and the aperture stop are approximately the same. If both positions are separated, it is not desirable since a loss and an unevenness of the amount of light would occur. Furthermore, as for the positions of a transmittance variable element and a multi-focal lens, it is desirable that they are arranged in adjacent position for the same reason.

In this embodiment, the positive lens in the positive lens group G62 is a multi-focal lens. As for the convex surface at an object side of this positive lens, the radius of curvature of the circumference to the optical axis is larger than the radius of curvature near the optical axis. That is, in the state of 6A where the circumferential portion of a transmittance variable element is penetrating, and the optical system has a long focal length. On the other hand, in the state of 6B where the central portion is penetrating, the optical system is of a short focal length.

It is possible to use the electrochromic element (ECD: Electrochromic Device) which performs reversibly coloring and decoloring by supplying voltage, and a liquid crystal element (LCD) as a transmittance variable element. By controlling electrically by using such elements, it is possible to perform a focussing function and a macro photographing function without arranging a movable part.

Furthermore, a multi-focus surface can also be formed as an aspherical surface or a free curved surface.

This embodiment is an example of the imaging apparatus which make it possible to perform a focussing adjustment or a macro photographing without arranging any mechanical movable part.

### Lens System in the Sixth Embodiment:

focal length f=1.77 mm,
field angle 2ω=76.0°
radius of curvature (r₅ at circumferential portion of the fifth surface at object distance ∞: r₅=1.6568
radius of curvature. (r_{5′}) at the near portion of optical axis of the fifth surface at object distance 10 mm: r_{5′}=1.5581

### Numerical Data

(optical system 62 wide angle system: FIG. 6A)
focal length f = 1.77 mm,
field angle 2ω = 76.0°,
object distance = ∞

| | | |
|---|---|---|
| r₁ = 4.3558 (aspherical) | | |
| d₁ = 0.3974 | n_{d1} = 1.48749 | ν_{d1} = 70.23 |
| r₂″ = 0.8919 | | |
| d₂ = 1.3166 | | |
| r₃ = ∞ | | |
| d₃ = 0.5000 | n_{d3} = 1.84666 | ν_{d3} = 23.78 |
| r₄ = ∞ | | |
| d₄ = 0.1000 | | |
| r₅ = 1.5581 | | |
| d₅ = 1.4289 | n_{d5} = 1.8044 | ν_{d5} = 46.57 |
| r₆ = −1.1736 | | |
| d₆ = 0.3990 | n_{d6} = 1.84666 | ν_{d6} = 23.28 |
| r₇ = −2.6231 (aspherical) | | |
| d₇ = 1.2906 | | |
| r₈ = ∞ | | |
| d₈ = 0.5000 | n_{d8} = 1.51633 | ν_{d8} = 64.15 |
| r₉ = ∞ (image plane) | | |

Aspherical coefficient
First surface

| | | |
|---|---|---|
| K = 0 | | |
| A₂ = 0 | A₄ = 2.0745 × 10⁻² | A₆ = 1.6133 × 10⁻² |
| A₈ = −1.2041 × 10⁻² | A₁₀ = 3.7535 × 10⁻³ | |

Seventh surface

| | | |
|---|---|---|
| K = 0 | | |
| A₂ = 0 | A₄ = 1.3933 × 10⁻¹ | A₆ = −1.7861 × 10⁻² |
| A₈ = 1.0363 × 10⁻¹ | A₁₀ = 7.8587 × 10⁻² | |

(optical system telephoto system: FIG. 6B)
r₅′ = 1.6568
Numerical data except r₅′ are the same in case of the wide angle system.

### Seventh Embodiment

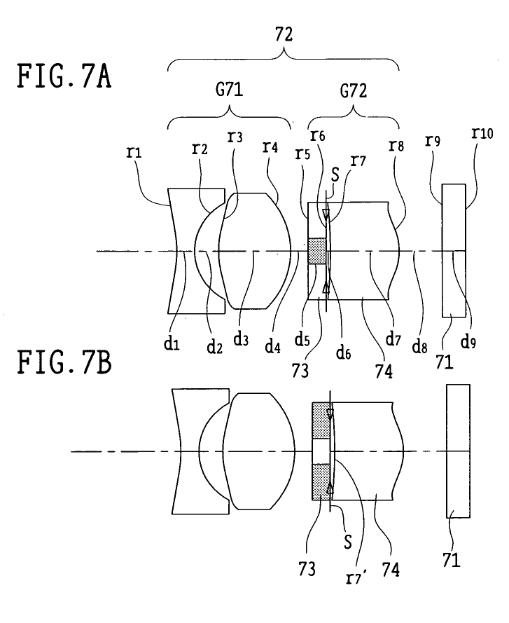

FIG. 7 is sectional views showing optical arrangements, developed along the optical axis about the seventh embodiment of the imaging apparatus according to the present invention.

In FIG. 7A, reference numeral 71 is imaging elements, such as CCD, CMOS and others. 72 is an optical system and 73 is a transmittance variable element. 74 is a multi-focus lens with the surface of an object side having partially different radius of curvature. FIG. 7 B is a diagram showing a state where the transmittance of a transmittance variable element is partially changed to FIG. 7A.

FIG. 7A shows a shaded state wherein the central part of the optical axis of the transmittance variable element 73 is shaded by a circle shape and a penetrating state wherein a circumferential part of the transmittance variable element is transparent by a ring like shape. On the other hand, FIG. 7B expresses a state wherein the circumference part of the transmittance variable element 73 is shaded and the central part of the optical axis of the transmittance variable element 73 is transparent.

The optical system in the seventh embodiment comprises a lens group G71 with positive power and a lens group G72 with positive power in order from an object side. The group 71 consists of a negative lens and a positive lens and the group 72 consists of a positive lens. In the optical system in this embodiment, a relatively wide angle lens system as an optical system having preceded negative lens is realized. The transmittance variable element is disposed between the positive lens group G71 and the positive lens group G72.

In this embodiment, the positive lens in the positive lens group G72 is a multi-focal lens. As for this positive lens, the radius of curvature of the circumference to the optical axis is smaller than the radius of curvature near the optical axis. In the state of 7A, it is an optical system with short focal length. On the other hand, in the state of 7B, it is an optical system with long focal length in focusing at the long distant object where the circumferential portion of a transmittance variable element is penetrating, and the optical system has a long focal length. This multi focus surface can be aspherical or free curved surface.

This embodiment is an example of an imaging apparatus which enables to perform focus adjustment or macro photographing without having a mechanical movable part.

### Lens System of the Seventh Embodiment:

focal length f=1.31 mm, field angle 2ω=76.1°radius of curvature (r₇) at circumferential portion of the seventh surface where the object distance is infinite r₇=11.002
radius of curvature (r_{7′}) at the central portion near the optical axis of the seventh surface where the object distance is 10 mm: r_{7′}=∞

### Numerical Data

(optical system for near distance object: FIG. 7A)
focal length f = 1.31 mm, field angle 2ω = 76.1°, object distance =
10 mm

| | | |
|---|---|---|
| r₁ = −2.1923 (aspherical) | | |
| d₁ = 0.4000 | n_{d1} = 1.65160 | ν_{d1} = 58.55 |
| r₂ = 1.2280 | | |
| d₂ = 0.5259 | | |
| r₃ = 1.7888 (aspherical) | | |
| d₃ = 1.6104 | n_{d3} = 1.72916 | ν_{d3} = 54.68 |
| r₄ = −1.8588 | | |
| d₄ = 0.4005 | | |
| r₅ = ∞ | | |
| d₅ = 0.4000 | n_{d5} = 1.51633 | ν_{d5} = 64.14 |
| r₆ = ∞ | | |
| d₆ = 0.1000 | | |
| r₇ = −11.0025 | | |
| d₇ = 1.5584 | n_{d7} = 1.4849 | ν_{d7} = 70.23 |
| r₈ = −1.2971 (aspherical) | | |
| d₈ = 0.9818 | | |
| r₉ = ∞ | | |
| d₉ = 0.5000 | n_{d9} = 1.51633 | ν_{d8} = 64.15 |
| r₁₀ = ∞ (image plane) | | |

aspherical coefficient
First surface

| | | |
|---|---|---|
| K = 0 | | |
| A₂ = 0 | A₄ = 2.1506 × 10⁻¹ | A₆ = −1.4317 × 10⁻¹ |
| A₈ = 6.3949 × 10⁻² | A₁₀ = −1.2828 × 10⁻² | |

Third surface

| | | |
|---|---|---|
| K = 0 | | |
| A₂ = 0 | A₄ = −1.5869 × 10⁻¹ | A₆ = 9.9631 × 10⁻² |
| A₈ = −1.0168 × 10⁻¹ | A₁₀ = 4.3295 × 10⁻² | |

Eighth surface

| | | |
|---|---|---|
| K = 0 | | |
| A₂ = 0 | A₄ = 1.6865 × 10⁻¹ | A₆ = 1.8184 × 10⁻² |
| A₈ = −1.5092 × 10⁻² | A₁₀ = 5.9984 × 10⁻² | |

(optical system for long distance object: FIG. 7B)
focal length f = 1.31 mm, field angle 2ω = 76.1, object distance = ∞
r₇′ = −11.002
Numerical data except r_{7′} are the same in case of in the optical system 72 for the near distance object.

### Eighth Embodiment

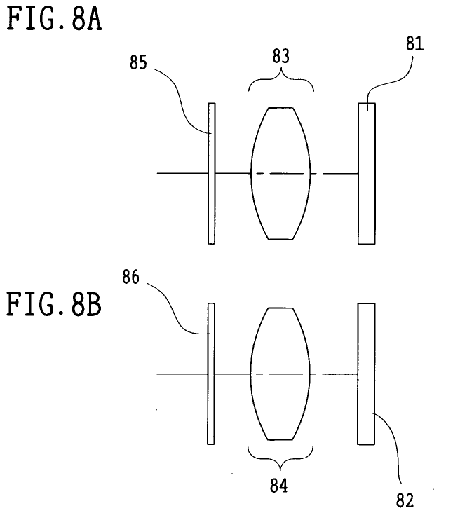

FIG. 8 is sectional views showing respectively optical arrangements, developed along the optical axis about the eighth embodiment of the imaging apparatus according to the present invention.

The imaging apparatus of this embodiment consists of imaging elements 81 and 82, optical systems 83 and 84, and transmittance variable elements 85 and 86 such as CCD, CMOS and others, and is characterized by using plural imaging units each of which consists of one optical system and one transmittance variable element to one imaging element. The optical system 83 and the optical system 84 are constituted by different specifications respectively. Moreover, it is also possible to use plural imaging units.

Since in this embodiment plural imaging elements are used, it requires the cost for them, but it is good to use in case that imaging units can be mass-produced cheaply.

### Ninth Embodiment

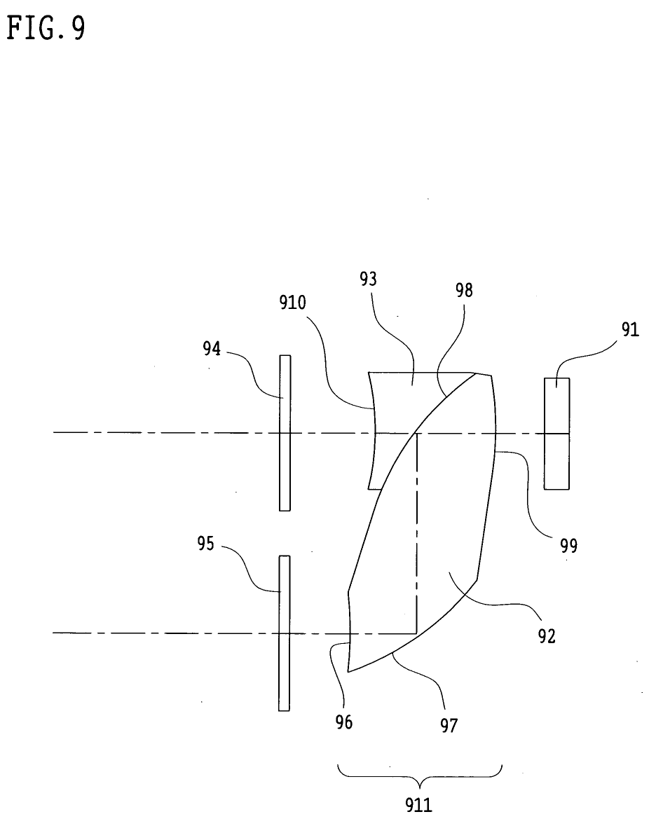

FIG. 9 is a sectional view showing an optical arrangement, developed along the optical axis about the ninth embodiment of the imaging apparatus according to the present invention.

In this embodiment, an imaging apparatus comprises an element 91 such as CCD, CMOS and others, an optical system 911 comprising prisms each of which has a refractive power in a reflective surface, and transmittance variable elements 94 and 95.

According to this embodiment, the imaging apparatus which is a compact and excellent at assembling since prisms with refractive power on its surface are adopted.

The optical system 911 consists of a prism 92 and a prism 93, and has two optical paths each of which has a different focal length respectively. The prism 92 has an incidence surface 96, a reflective surface 97, a junction surface 98 and an ejection surface 99 of luminous flux. The prism 93 has an incidence surface 910 and a junction surface 8. The prism 92 and the prism 93 are joined in the junction surface 98.

A luminous flux which penetrated the transmittance variable element 94 penetrates the incidence surface 910 of the prism 93, the junction surface 98, and the ejection surface 99 of the prism 92 in order, and enters into the imaging element 91. This is the first optical path. The prism 93 has a function of a lens because the incidence surface 910 and the ejection surface 99 have shapes which have a refractive power. On the other hand, the luminous flux which penetrated the transmittance variable element 95 enters into the imaging element 91 in order, via the incidence surface 96 of a prism 92, the reflective surface 97, the junction surface 98 and the ejection surface 99. This is the second optical path. The prism 92 has a function of a lens because the incidence surface 96, the reflective surface 97 and the ejection surface 99 have the shape which has the power. Moreover, the junction surface 98 has a function of a half mirror and a function transmitting the luminous flux by the first optical path and a function reflecting the luminous flux at the second optical path. The reflective surface 98 can also be formed to have the power. Moreover, the ejection surface 99 is a surface shared by the first optical path and the second optical path.

Each of the penetration surface and the reflective surface can be constituted by a surface of a sphere, an aspherical surface, a free curved surface or others. In particular, considering that aberration of decentering may occur because the reflective surface has refractive power, it is desirable to use a free curved surface in order to compensate such aberration.

### Tenth Embodiment

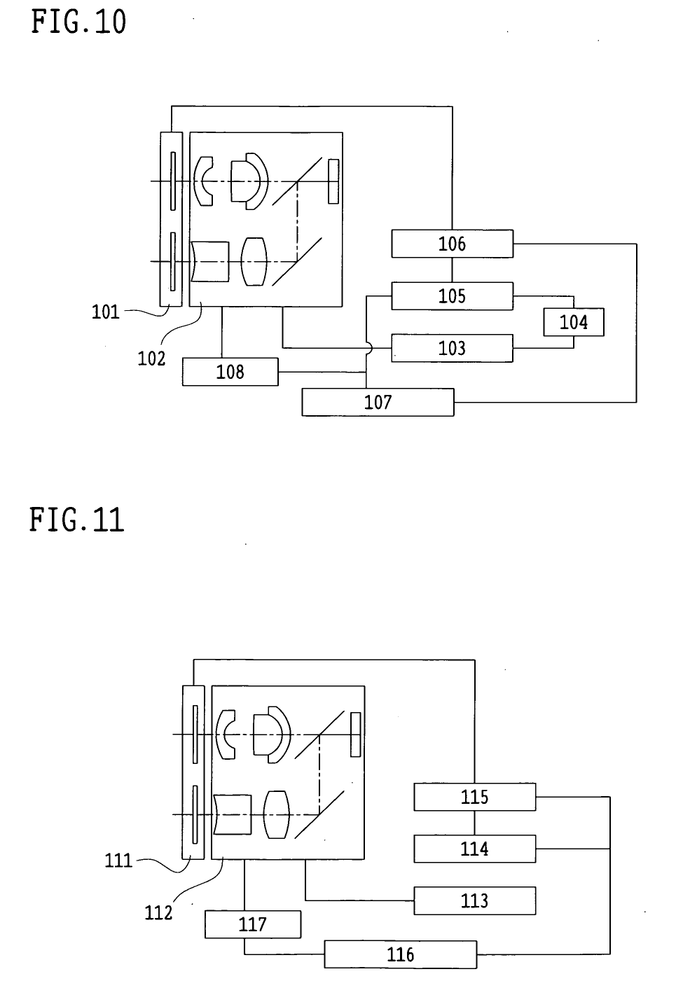

FIG. 10 is a diagram showing outlined constitution of the tenth embodiment of the imaging apparatus according to the present invention.

Here, an example is shown for applying to mobile apparatus such as a cellular phone and a personal digital terminal, and digital cameras and others. In an imaging apparatus 1 of this embodiment, 102 is an imaging unit which has a penetration variable element 101 and an optical system and an imaging element. 103 is a display part for checking a photographing state. 104 is a check part which checks the photographing state displayed on the display part 103. 105 is an operation part for choosing an optical system of a desired specification. Moreover, 106 is a control part for controlling the transmittance variable element 101. 107 is a power supply part which supplies electric power to each function part which needs electric power. 105 is a recording part which records a photographed picture.

In this imaging apparatus, a person photographing checks the picture displayed on the display part 103, and selects a desired optical system for an operation. This selected information is sent to the control part 106. The control part 106 controls the transmittance of the transmittance variable element 101 to the desired value based on selected information. Then, a photograph is taken by the imaging unit 102. The photographed picture performs record to the record part 108 while displaying it on the display part 103. From the power supply part 107, electric power is supplied to the display part 103, the transmittance variable element 101, the control part 106, and the record part 108. After a photographing is completed, it is desirable to reset the transmittance variable element 101 to the initial state in order to prepare for the next photographing.

### Eleventh Embodiment

FIG. 11 is a diagram showing outlined constitution of the eleventh embodiment of the imaging apparatus according to the present invention.

Here, an example is shown in applying for a vehicle camera, a camera for security and FA, and others, in case that mainly automatically selecting a photographing condition is required. The imaging apparatus of this embodiment consists of a transmittance variable element 111, an optical system, an imaging unit 112 that has a imaging element, a sensor part 113 for checking a photography state, an operation processing part 114 which calculates the signal from this sensor part 113, a control part 115 which controls the transmittance variable element 111 in order to select the optical system of a desired specification from an operation result, a power supply part 116 and a record part 117.

In this imaging apparatus, an optical system which is suitable for a environment is automatically selected by carrying out operation processing of the information from a photographed picture or the information from other sensor part. The transmittance of the transmittance variable element 111 is controlled to a desired value by the selected signal, and after that a photograph is taken by the imaging unit 112. A photographed picture is recorded on the record part 117 if necessary. From the power supply part 116, electric power is supplied to the transmittance variable element 111, the operation processing part 114, the control part 115 and the record part 117. After photographing is completed, it is desirable to return the transmittance variable element 111 to an initial state in order to prepare for the next photographing. It is also possible to arrange a display part in the constitution according to this embodiment.

### Twelfth Embodiment

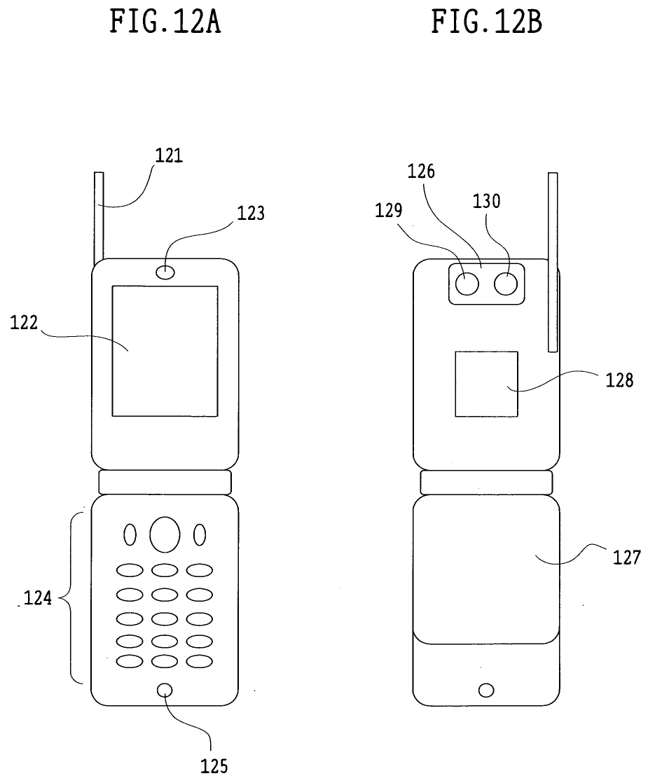

FIG. 12 shows outlined constitution of the twelfth embodiment of the imaging apparatus according to the present invention.

This embodiment shows an example where the imaging apparatus of the present invention is applied to a cellular phone. In FIG. 12, reference numeral 121 is an antenna for transmitting and receiving an electric wave and 122 is a display parts, such as LCD, 123 is a sound and 124 is an operation part and 125 is a microphone part, and in the rear side an imaging apparatus part 126, a battery part and a rear side monitor 128 are arranged.

In this embodiment, as an example, two optical systems 129 and are arranged in the imaging apparatus, and 129 and 130 are optical systems each of which has different specifications as to focal length or photographing magnification and others, respectively. The various optical systems shown in each embodiment mentioned above can be equipped in the imaging apparatus in this embodiment.

Furthermore, as a transmittance variable element used in this embodiment, a liquid crystal element (LCD), an electrochromic element (ECD) or light control mirror using film of magnesium-nickel alloy can be adopted.

According to the present invention, a cheap and small imaging apparatus in which a focal length can be changed without having a movable part with compact constitution can be offered.

1-18. (canceled)

19. An imaging apparatus comprising:
an imaging element;
plural optical systems having different focal lengths;
a variable-transmittance element; and
a reflective optical element;
wherein a focal length of the imaging apparatus in its entirety is changed by controlling transmittance of the variable-transmittance element, and
wherein each of the optical systems comprises, in order from an object side, a first lens group with negative power and a second lens group with positive power.

20. An imaging apparatus comprising:
an imaging element;
plural optical systems having different focal lengths;
a variable-transmittance element; and
a reflective optical element;
wherein a focal length of the imaging apparatus in its entirety is changed by controlling transmittance of the variable-transmittance element, and
wherein each of the optical systems comprises at least one negative lens and at least one positive lens, and in each of the optical systems, a lens arranged on an utmost object side is one of the at least one negative lens.

21. An imaging apparatus comprising:
an imaging element;
plural optical systems having different focal lengths;
a variable-transmittance element; and
a reflective optical element;
wherein a focal length of the imaging apparatus in its entirety is changed by controlling transmittance of the variable-transmittance element, and
wherein one of the plural optical system is constructed as a telephoto lens and another of the plural optical systems is constructed as a wide angle lens, and the following condition is satisfied:
1.9<fT/fW
where fT is a focal length of the telephoto lens, and fw is a focal length of the wide angle lens.

22-23. (canceled)
